(19) United States
(12) Patent Application Publication
(10) Pub. No.: US 2016/0188788 A1
(43) Pub. Date: Jun. 30, 2016

(54) TECHNOLOGIES FOR TUNING A BIO-CHEMICAL SYSTEM

(71) Applicants: John C. Weast, Portland, OR (US); Brian D. Johnson, Portland, OR (US)

(72) Inventors: John C. Weast, Portland, OR (US); Brian D. Johnson, Portland, OR (US)

(21) Appl. No.: 14/583,700

(22) Filed: Dec. 27, 2014

(51) Int. Cl. G06F 19/12

(52) U.S. Cl. CPC G06F 19/12

(57) ABSTRACT

Technologies for bio-chemically controlling operation of a machine are disclosed.

### BACKGROUND

Biological and chemical systems vary greatly from one to the other. The variance in such systems causes difficulties in producing products for biological and/or chemical systems. Additionally, few technologies allow the monitoring of biological and/or chemical systems on a regular and repeatable basis. As such, the design process of engineered products for biological and/or chemical systems tends to be “open loop,” in that little to no active feedback is provided. As such, many products may be engineered with little insight into the likely impact of the product once it is placed into the biological and/or chemical systems or the response of such systems to the product. Further, even if a particular sate of a biological and/or chemical system is determined, it is quite difficult to deploy a modification to the biological and/or chemical system.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system generating a bio-chemical product;

FIG. 2 is a simplified block diagram of at least one embodiment of an environment that may be established by a digital modeling system of the system of FIG. 1;

FIG. 3 is a simplified flow diagram of at least one embodiment of a method for generating a digital model of a bio-chemical system; and

FIG. 4 is a simplified flow diagram of at least one embodiment of a method for manufacturing a product for a bio-chemical system utilizing the digital model of FIG. 3.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C): (A and B); (B and C); (A and C); or (A, B, and C). Similarly, items listed in the form of “at least one of A, B, or C” can mean (A); (B); (C): (A and B); (B and C); (A or C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

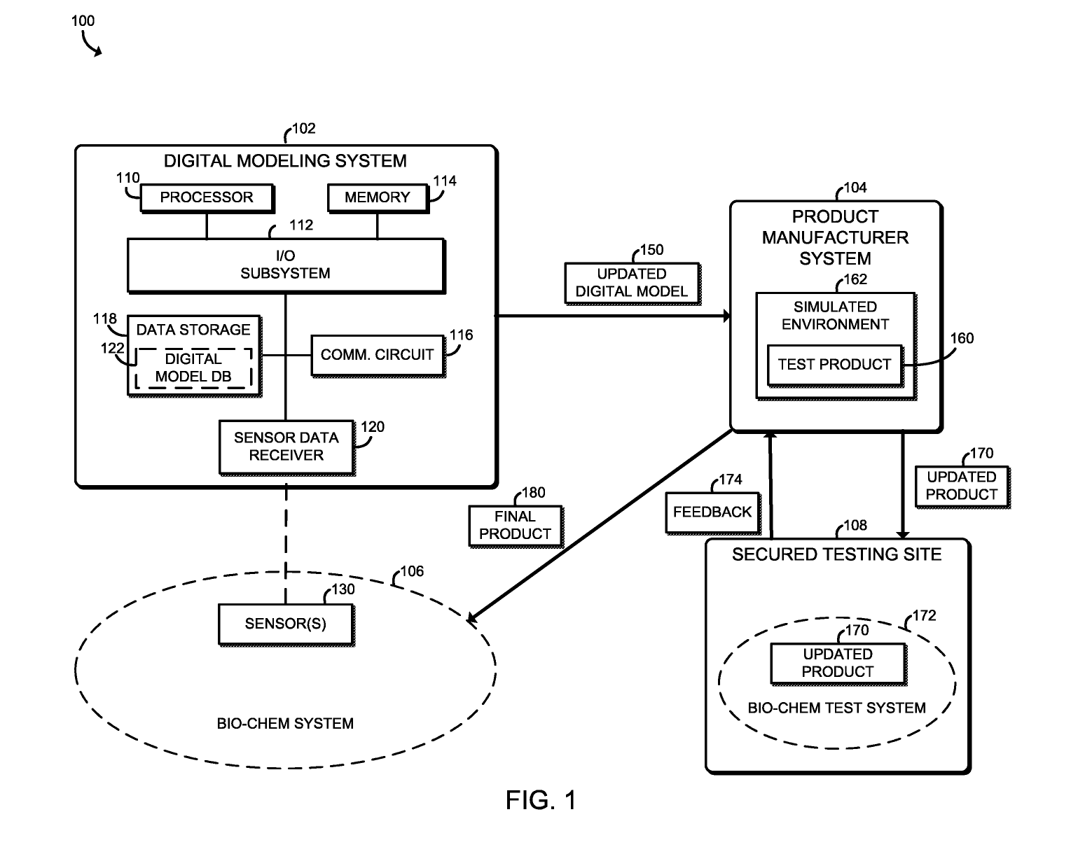

Referring now to FIG. 1, a system 100 for generating a bio-chemical system product includes a digital modeling system 102 and a product manufacture system 104. In use, as discussed in more detail below, the digital modeling system 102 is configured to generate a digital model of a bio-chemical system 106. To do so, the digital modeling system 102 may obtain or estimate an initial digital model for the bio-chemical system 106. For example, the initial digital model may be obtained from a pre-exiting sample. Additionally, in some embodiments, the digital model need not be complete (e.g., the digital model may be 80% accurate). It should be appreciated that the digital model is embodied a digital representation of the bio-chemical system 106 and may model the behavior, functions, and/or reactions of the bio-chemical system 106. For example, a digital model of the bio-chemical system 106 may react to the introduction of a bio-chemical system product in a manner substantially similar to the actual bio-chemical system 106. As such, digital modeling of a complex bio-chemical system 106 provides some amount of feedback and predictability in the design of bio-chemical products for such systems.

The initial digital model of the bio-chemical system 106 is further modified and improved to better model the behavior of the bio-chemical system 106. To do so, one or more bio-chemical sensors 130 are introduced into the bio-chemical system to measure various bio-chemical aspects of the bio-chemical system 106. The sensor data generated by the sensor 130 is collected by the digital modeling system 102 and used to refine the digital model. Such process may be repeated to further improve the digital model.

Once the digital model appears to properly model the bio-chemical system 106, the updated digital model 150 is provided to the product manufacturer system 104. The product manufacture system 104 generates a test product 160 based on the updated digital model. It should be appreciated that the test product 160 may be better suited or perform in a better manner because the test product 160 is designed based on the updated digital model 150. Once the test product 160 is initially designed, the product manufacturer system 104 may perform one or more tests of the product in a simulated environment 162. For example, the product manufacturer may generate a simulated bio-chemical system representing the bio-chemical system 106 and test the test product 160 within the simulated environment 162. The product manufacturer may revise and update the test product 160 based on the results of the simulated test.

Once the product manufacturer system 104 finalizes the test product 160 based on the simulated environment, the product manufacturer system 104 generates an updated product 170 based on the simulated tests. The product manufacturer system 104 may then perform limited, secured testing of the updated product 170 in a controlled, real-world environment at a secured testing site 108. For example, the product manufacturer system 104 may test the updated product 170 in a bio-chemical test system 172, which may be engineered from the digital model. The updated product 170 may be further revised during that process based on feedback 174 form the secured testing site 108. Once the product manufacturer system 104 has finalized the product, the product manufacturer system 104 may release the final product 180 into the bio-chemical system 106 and/or the market at large. In this way, the manufacture of a bio-chemical system product may be improved utilizing a digital modeling of the target bio-chemical system.

The digital modeling system 102 may be embodied as any type of computer system capable of generating the digital model 150 and performing the other functions described herein. For example, the digital modeling system 102 may be embodied as a computer, a controller, a server, a server controller, a distributed computing system, a multiprocessor system, a multi-computer system, a computerized machine, and/or other computing device capable of generating a digital model of a bio-chemical system. It should be appreciated that although the digital modeling system 102 is illustrated in FIG. 1 as a single computing device, the digital modeling system 102 may be embodied as a collection or network individual computing devices in some embodiments.

As shown in FIG. 1, the digital modeling system 102 includes a processor 110, an I/O subsystem 112, memory 114, a communication circuit 116, a data storage 118, and a sensor data receiver 120. Of course, the digital modeling system 102 may include other or additional components, such as those commonly found in a computer device (e.g., various input/output devices), in other embodiments. Additionally, in some embodiments, one or more of the illustrative components may be incorporated in, or otherwise from a portion of, another component. For example, the memory 114, or portions thereof, may be incorporated in the processor 110 in some embodiments.

The processor 110 may be embodied as any type of processor capable of performing the functions described herein. For example, the processor may be embodied as a single or multi-core processor(s), digital signal processor, microcontroller, or other processor or processing/controlling circuit. Similarly, the memory 114 may be embodied as any type of volatile or non-volatile memory or data storage capable of performing the functions described herein. In operation, the memory 114 may store various data and software used during operation of the digital modeling system 102 such as operating systems, applications, programs, libraries, and drivers. The memory 114 is communicatively coupled to the processor 110 via the I/O subsystem 112, which may be embodied as circuitry and/or components to facilitate input/output operations with the processor 110, the memory 114, and other components of the digital modeling system 102. For example, the I/O subsystem 112 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations. In some embodiments, the I/O subsystem 112 may form a portion of a system-on-a-chip (SoC) and be incorporated, along with the processor 110, the memory 114, and other components of the digital modeling system 102, on a single integrated circuit chip.

The communication circuit 116 may be embodied as any communication circuit, device, or collection thereof, capable of enabling communications between the digital modeling system 102 and the product manufacturer system 104. To do so, the communication circuit 116 may be configured to use any one or more communication technology and associated protocols (e.g., Ethernet, Bluetooth®, Wi-Fi®, WiMAX, etc.) to effect such communication.

The data storage 118 may be embodied as any type of device or devices configured for the short-term or long-term storage of data. For example, the data storage 118 may include any one or more memory devices and circuits, memory cards, hard disk drives, solid-state drives, or other data storage devices. In some embodiments, the data storage 118 may store the digital models 150 (e.g., the initial digital models) in a digital model database 122.

In some embodiments, the digital modeling system 102 may also include one or more peripheral devices (not shown). Such peripheral devices may be embodied as any type of peripheral device commonly found in a typical computing device, such as various input/output devices. For example, the peripheral devices may include display circuitry, various input buttons and switches, a keyboard, a mouse, speaker, microphone, and/or other peripheral devices.

The sensor data receiver 120 may be embodied as any type of device capable of receiving sensor data from the sensors 130. For example, the sensor data receiver 120 may be embodied as a communication circuit configured to receive transmission from the sensors 130. Alternatively, the sensor data receiver 120 may be embodied as a data file including the sensor readings from the sensors 130. Depending on the particular implementation, the sensor data receiver 120 may be embodied as any structure or device useable to obtain, receive, or submit the sensor data form the sensors 130.

The product manufacturer system 104 may be embodied as any type of manufacturing system capable of manufacturing a bio-chemical system product for a bio-chemical system. As such, the product manufacturer system 104 may include various machines and processes for manufacturing a bio-chemical product. The particular bio-chemical system product manufactured by the product manufacturer system 104 may depend on, for example, the type of bio-chemical system 106. For example, the bio-chemical system product may be embodied as a drug or treatment, soil treatment, repellant, or other product for use in or with the bio-chemical system 106.

The bio-chemical system 106 may be embodied as any type of biological, chemical, or biological-chemical system for which a digital model may be fabricated. As such, as used herein, the term “bio-chemical” means biological, chemical, or biological-chemical. For example, the bio-chemical system 106 may be embodied as an animal, a plant, a soil, or other biological system, chemical system, or biological-chemical system.

Each of the sensors 130 may be embodied as any type of sensor capable of measuring a bio-chemical characteristic or parameter of the bio-chemical system 106 useful in designing the digital model. For example and depending on the type of biological-chemical system 106, the sensors 130 may be embodied as, for example, a digital or injectable pill for livestock, a mote mesh for soil, implantable gene sequencers, or any other type sensor capable of measuring a bio-chemical characteristic or parameter. In some embodiments, multiple sensors 130 may be used in the bio-chemical system 106 to measure different characteristics or parameters.

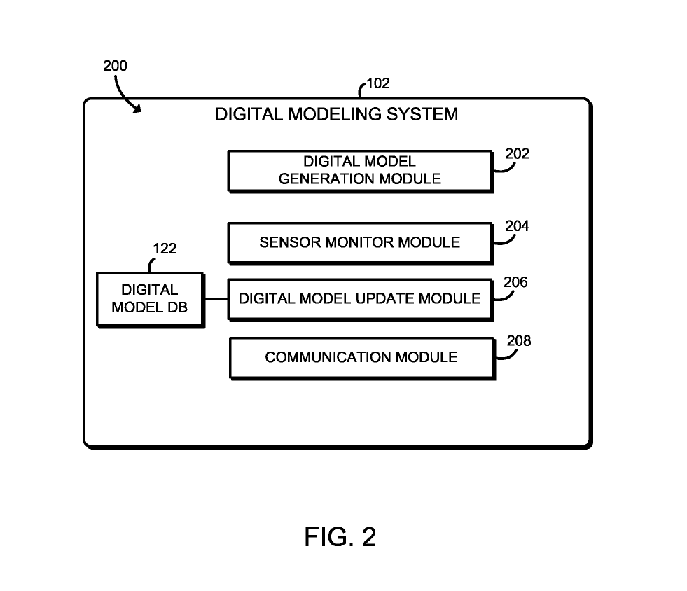

Referring now to FIG. 2, in use, the digital modeling system 102 may establish an environment 200. The illustrative environment 200 includes a digital model generation module 202, a sensor monitor module 204, a digital model update module 206, and a communication model 208. Each of the modules and other components of the environment 200 may be embodied as firmware, software, hardware, or a combination thereof. For example the various modules, logic, and other components of the environment 200 may form a portion of, or otherwise be established by, the processor 110, the I/O subsystem 112, an SoC, or other hardware components of the digital modeling system 102. As such, in some embodiments, any one or more of the modules of the environment 200 may be embodied as a circuit or collection of electrical devices (e.g., digital model generation circuit, a sensor monitor circuit, a digital model update circuit, a communication circuit, etc.).

The digital model generation module 202 is configured to generate or obtain an initial digital model of the bio-chemical system 106 of interest. To do so, the digital model generation module 202 may generate an initial model based on a sample or on known values or characteristics. As the initial digital model will be updated based on the sensor data generated by the sensors 130, the initial model may be allowed to be inaccurate to a certain degree.

The sensor monitor module 204 is configured to monitor the various sensors 130 injected, implanted, or otherwise introduced into the bio-chemical system 106. As discussed above, in some embodiments, the sensors 130 may be include wireless communication capabilities and be configured to transmit the sensor data from the bio-chemical system 106. The sensor monitor module 204 receives the sensor data from the sensors 130, conditions or aggregates the data as needed, and provides the data to the digital model update module 206.

The digital model update module 260 is configured to update the initial or on-going digital model of the bio-chemical system 106 based on the received sensor data. In this way, the digital model update module 206 improves the accuracy of the digital model relative to the bio-chemical system 106. To update the digital model, the digital model update module 206 may perform any type of modification, alteration, or update to the digital model to improve its representation of the bio-chemical system 106. After the digital model has been updated to a satisfactory degree based on the sensor data, the digital modeling system 102 may transmit or provide the updated digital model 150 to the product manufacturer system 104.

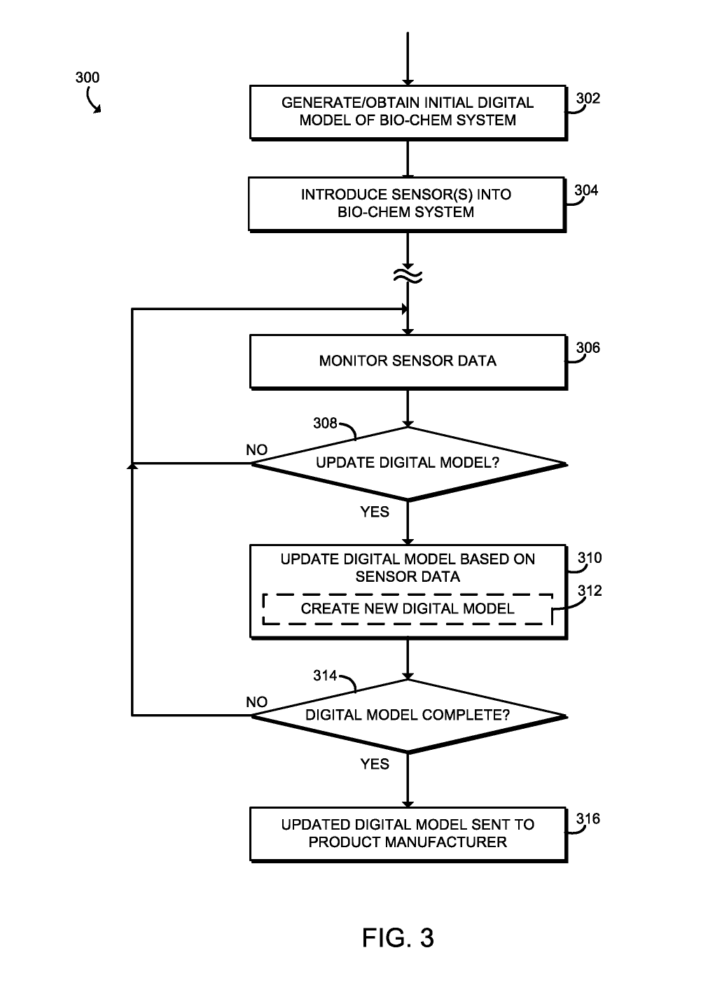

Referring now to FIG. 3, in use, the digital modeling system 102 may execute a method 300 for generating a digital model of a bio-chemical system 106. The method 300 begins with block 302 in which the digital modeling system 102 generates and/or obtains the initial digital model of the bio-chemical system 106. As discussed above, the digital modeling system 102 may generate an initial model based on a sample or on known values or characteristics. Subsequently, in block 304, the sensors 130 are introduced to the bio-chemical system 106. As discussed above and depending on the type of sensor, the sensors may be swallowed, injected, implanted, or otherwise applied to the bio-chemical system 106.

After the sensors 130 have been introduced to the bio-chemical system 106, the digital modeling system 102 begins monitoring the sensor data in block 306. In block 308, the digital modeling system 102 determines whether an update to the digital model is required based on the sensor data. For example, the digital modeling system 102 may have an expectation of the type, values, magnitude, or other quality of the senor data indicative of characteristics of the bio-chemical system 106 based on the digital model. If the sensor data varies from the expected values based on the digital model, the digital modeling system 102 may update or refine the digital model such that the expected results match those of the sensors 130 in block 310. Additionally, in some embodiments, the digital modeling system 102 may generate a new digital model based on the recently received sensor data in block 312.

In some embodiments, an existing digital model of a bio-chemical system 106 may be updated based on treatment or introduction of a bio-chemical system product to the bio-chemical system 106. In this way, the generation of the digital model is a form of feedback control for the bio-chemical system 106, which allows future bio-chemical system products to be according to the feedback.

After the digital model has been updated, the method 300 advances to block 314 in which the digital modeling system 102 determines whether the digital model is complete for the current iteration. If not, the method 300 loops back to block 306 in which the digital modeling system 102 continues monitoring sensor data from the sensors 130. If, however, the digital model is determined to be complete in block 314 (for at least this iteration), the method 300 advances to block 316 in which the updated digital model is sent to the product manufacturer system 104. Of course, the process of the method 300 may be repeated again to further update the digital model (e.g., in response to introduction of a bio-chemical system product from the product manufacturer system 104).

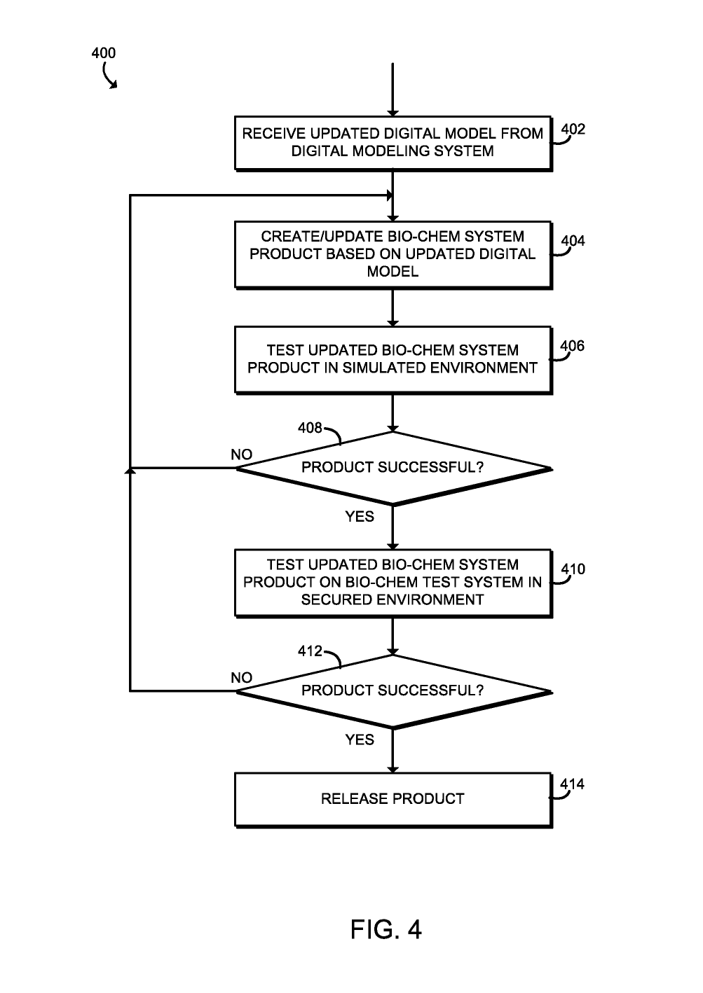

Referring now to FIG. 4, in use, the product manufacturer system 104 may execute a method 400 for manufacturing a product for a bio-chemical system 106 utilizing a digital model of the bio-chemical system 106. The method 400 begins with block 402 in which the product manufacturer system 104 receives the updated digital model from the digital modeling system 102. In block 402, the product manufacturer system 104 creates or updates a test bio-chemical system product based on the updated digital model. Again, it should be appreciated that the test product 160 may be better suited or perform in a better manner because the updated bio-chemical system product is designed based on the updated digital model. Subsequently, in block 406, the product manufacturer system 104 tests the updated bio-chemical system product in a simulated environment. For example, the product manufacturer system 104 may generate a simulated bio-chemical system representing the bio-chemical system 106 and test the updated bio-chemical system product within the simulated environment

Subsequently, in block 408, the product manufacturer system 104 determines whether the simulated environment test of the updated bio-chemical system product was successful. If not, the method 400 loops back to block 404 in which the product manufacturer system 104 may further update bio-chemical system product based on the digital model or other data. If, however, the simulated test was successful, the method 400 advances to block 410 in which the product manufacturer system 104 tests the updated bio-chemical system product on a bio-chemical test system in a secured, limited or controlled, real-world environment at, for example, a secured testing site. For example, the product manufacturer system 104 may test the updated bio-chemical system product in a bio-chemical test system that is engineered from the digital model so as to better represent the real-world bio-chemical system 106.

Subsequently, in block 412, the product manufacturer system 104 determines whether the secured test of the updated bio-chemical system product was successful. If not, the method 400 loops back to block 404 in which the product manufacturer system 104 may further update bio-chemical system product based on the digital model or other data. If, however, the secured test of the updated bio-chemical system product was successful, the product manufacturer system 104 may release the product in block 414. For example, the updated bio-chemical system product may be reintroduced into the bio-chemical system 106.

In response to the introduction of the bio-chemical system product, the digital modeling system 102 may update the digital model of the bio-chemical system 106 and the model design-manufacturing process may repeat itself. In this way, the system 100 exhibits an amount of feedback control and analysis in the manufacture of bio-chemical system products.

### EXAMPLES

Illustrative examples of the devices, systems, and methods disclosed herein are provided below. An embodiment of the devices, systems, and methods may include any one or more, and any combination of, the examples described below.

Example 1 includes a system for producing a bio-chemical system product for a bio-chemical system. The system includes a digital model generation module to generate an initial digital model of the bio-chemical system; a sensor monitor module to receive sensor data from one or more bio-chemical sensors introduced into the bio-chemical system, wherein each bio-chemical sensor is configured to measure a bio-chemical aspect of the bio-chemical system; and a digital model update module to update the digital model based on the sensor data.

Example 2 includes the subject matter of Example 1, and wherein the digital model is a digital representation of the bio-chemical system.

Example 3 includes the subject matter of any of Examples 1 and 2, and wherein the bio-chemical system comprises an animal, a plant, or soil.

Example 4 includes the subject matter of any of Examples 1-3, and wherein to the one or more bio-chemical sensors are injected into the bio-chemical sensor into an animal.

Example 5 includes the subject matter of any of Examples 1-4, and wherein the one or more bio-chemical sensors comprises a digital pill, an injectable pill, a mote mesh, or an implantable gene sequencers.

Example 6 includes the subject matter of any of Examples 1-5, and wherein to receive the sensor data comprises to wirelessly receive the sensor data.

Example 7 includes the subject matter of any of Examples 1-6, and wherein to update the digital model comprises to generate a new digital model of the bio-chemical system.

Example 8 includes the subject matter of any of Examples 1-7, and further comprising a product manufacturing system to receive the digital model

Example 9 includes the subject matter of any of Examples 1-8, and wherein the product manufacturing system is to produce a bio-chemical system product based on the digital model.

Example 10 includes the subject matter of any of Examples 1-9, and wherein the product manufacturing system is to test the bio-chemical system product.

Example 11 includes the subject matter of any of Examples 1-10, and wherein to test the bio-chemical system product comprises to test the bio-chemical system product in a simulated bio-chemical system based on the digital model.

Example 12 includes the subject matter of any of Examples 1-11, and wherein to test the bio-chemical system product comprises to test the bio-chemical system product in a bio-chemical test system, wherein the bio-chemical test system is based on the digital model.

Example 13 includes the subject matter of any of Examples 1-12, and wherein the product manufacturing system is to the bio-chemical system product based on a result of the testing.

Example 14 includes the subject matter of any of Examples 1-13, and wherein the product manufacturing system is to introduce the bio-chemical system product into the bio-chemical system.

Example 15 includes the subject matter of any of Examples 1-14, and wherein the digital model update module is to update the digital model based on a variance of the bio-chemical system caused by the bio-chemical system product and the sensor data.

Example 16 includes a method for producing a bio-chemical system product for a bio-chemical system. The method includes generating, by a digital modeling system, an initial digital model of the bio-chemical system; introducing, by the digital modeling system, one or more bio-chemical sensors into the bio-chemical system, wherein each bio-chemical sensor is configured to measure a bio-chemical aspect of the bio-chemical system; receiving, by the digital modeling system, sensor data from the bio-chemical sensors; and updating, by the digital modeling system the digital model based on the sensor data.

Example 17 includes the subject matter of Example 16, and wherein the digital model is a digital representation of the bio-chemical system.

Example 18 includes the subject matter of any of Examples 16 or 17, and wherein the bio-chemical system comprises an animal, a plant, or soil.

Example 19 includes the subject matter of any of Examples 16-18, and wherein introducing the one or more bio-chemical sensors comprises injecting the bio-chemical sensor into an animal.

Example 20 includes the subject matter of any of Examples 16-19, and wherein the one or more bio-chemical sensors comprises a digital pill, an injectable pill, a mote mesh, or an implantable gene sequencers.

Example 21 includes the subject matter of any of Examples 16-20, and wherein receiving the sensor data comprises wirelessly receiving the sensor data.

Example 22 includes the subject matter of any of Examples 16-21, and wherein updating the digital model comprises generating a new digital model of the bio-chemical system.

Example 23 includes the subject matter of any of Examples 16-22, and wherein further comprising providing the digital model to a product manufacturing system.

Example 24 includes the subject matter of any of Examples 16-23, and producing, by the product manufacturing system, a bio-chemical system product based on the digital model.

Example 25 includes the subject matter of any of Examples 16-24, and further comprising testing, by the product manufacturing system, the bio-chemical system product.

Example 26 includes the subject matter of any of Examples 16-25, and wherein testing the bio-chemical system product comprises testing the bio-chemical system product in a simulated bio-chemical system based on the digital model.

Example 27 includes the subject matter of any of Examples 16-26, and wherein testing the bio-chemical system product comprises testing the bio-chemical system product in a bio-chemical test system, wherein the bio-chemical test system is based on the digital model.

Example 28 includes the subject matter of any of Examples 16-27, and further comprising updating the bio-chemical system product based on a result of the testing.

Example 29 includes the subject matter of any of Examples 16-28, and further comprising introducing the bio-chemical system product into the bio-chemical system.

Example 30 includes the subject matter of any of Examples 16-29, and further comprising updating, by a digital modeling system, the digital model based on a variance of the bio-chemical system caused by the bio-chemical system product and the sensor data.

Example 31 includes one or more computer-readable storage media comprising a plurality of instructions stored thereon that, in response to execution, cause a computing device to perform the method of any of Examples 16-30.

Example 32 includes system for producing a bio-chemical product for a bio-chemical system computing device, the computing device comprising means for performing the method of any of Examples 16-30.

1-25. (canceled)

26. A system for producing a bio-chemical system product for a bio-chemical system, the system comprising:
a digital model generation module to generate an initial digital model of the bio-chemical system;
a sensor monitor module to receive sensor data from one or more bio-chemical sensors introduced into the bio-chemical system, wherein each bio-chemical sensor is configured to measure a bio-chemical aspect of the bio-chemical system; and
a digital model update module to update the digital model based on the sensor data.

27. The system of claim 26, wherein the digital model is a digital representation of the bio-chemical system.

28. The system of claim 26, wherein the sensor monitor module is to receive sensor data from one or more bio-chemical sensors injected into the bio-chemical sensor into an animal.

29. The system of claim 26, wherein to update the digital model comprises to generate a new digital model of the bio-chemical system.

30. The system of claim 26, further comprising a product manufacturing system to receive the digital model.

31. The system of claim 30, wherein the product manufacturing system is to produce a bio-chemical system product based on the digital model.

32. The system of claim 31, wherein the product manufacturing system is to test the bio-chemical system product.

33. The system of claim 32, wherein the product manufacturing system is to update the bio-chemical system product based on a result of the testing.

34. The system of claim 32, wherein:
the product manufacturing system is to introduce the bio-chemical system product into the bio-chemical system, and
the digital model update module is to update the digital model based on a variance of the bio-chemical system caused by the bio-chemical system product and the sensor data.

35. One or more computer-readable storage media comprising a plurality of instructions stored thereon that, in response to execution, cause a system to:
generate, by a digital modeling system of the system, an initial digital model of the bio-chemical system;
introduce, by the digital modeling system, one or more bio-chemical sensors into the bio-chemical system, wherein each bio-chemical sensor is configured to measure a bio-chemical aspect of the bio-chemical system;
receive, by the digital modeling system, sensor data from the bio-chemical sensors; and
update, by the digital modeling system the digital model based on the sensor data.

36. The one or more computer-readable storage media of claim 35, wherein the digital model is a digital representation of the bio-chemical system.

37. The one or more computer-readable storage media of claim 35, wherein to introduce the one or more bio-chemical sensors comprises to inject the bio-chemical sensor into an animal.

38. The one or more computer-readable storage media of claim 35, wherein to update the digital model comprises to generate a new digital model of the bio-chemical system.

39. The one or more computer-readable storage media of claim 35, wherein the plurality of instructions further cause the system to provide, by the digital modeling system, the digital model to a product manufacturing system of the system.

40. The one or more computer-readable storage media of claim 39, wherein the plurality of instructions further cause the system to produce, by a product manufacturing system, a bio-chemical system product based on the digital model.

41. The one or more computer-readable storage media of claim 40, wherein the plurality of instructions further cause the system:
test, by the product manufacturing system, the bio-chemical system product; and
update, by the product manufacturing system, the bio-chemical system product based on a result of the testing.

42. The one or more computer-readable storage media of claim 41, wherein the plurality of instructions further cause the system to:
introduce, by the product manufacturing system, the updated bio-chemical system product into the bio-chemical system; and
update, by the digital modeling system, the digital model based on a variance of the bio-chemical system caused by the updated bio-chemical system product and the sensor data.

43. A method for producing a bio-chemical system product for a bio-chemical system, the method comprising:
generating, by a digital modeling system, an initial digital model of the bio-chemical system;
introducing, by the digital modeling system, one or more bio-chemical sensors into the bio-chemical system, wherein each bio-chemical sensor is configured to measure a bio-chemical aspect of the bio-chemical system;
receiving, by the digital modeling system, sensor data from the bio-chemical sensors; and
updating, by the digital modeling system the digital model based on the sensor data.

44. The method of claim 43, wherein the digital model is a digital representation of the bio-chemical system.

45. The method of claim 43, wherein introducing the one or more bio-chemical sensors comprises injecting the bio-chemical sensor into an animal.

46. The method of claim 43, wherein updating the digital model comprises generating a new digital model of the bio-chemical system.

47. The method of claim 43, further comprising providing the digital model to a product manufacturing system.

48. The method of claim 47, further comprising producing, by the product manufacturing system, a bio-chemical system product based on the digital model.

49. The method of claim 48, further comprising:
testing, by the product manufacturing system, the bio-chemical system product; and
updating the bio-chemical system product based on a result of the testing.

50. The method of claim 49, further comprising:
introducing the updated bio-chemical system product into the bio-chemical system; and
updating, by the digital modeling system, the digital model based on a variance of the bio-chemical system caused by the updated bio-chemical system product and the sensor data.
